(19) United States
(12) Patent Application Publication
(10) Pub. No.: US 2006/0131035 A1
(43) Pub. Date: Jun. 22, 2006

(54) Self-contained modular fire extinguishing system

(76) Inventor: Kenneth French, Aromas, CA (US)

Correspondence Address: CENTRAL COAST PATENT AGENCY, PO BOX 187, AROMAS, CA, 95004, US

(21) Appl. No.: 11/104,996

(22) Filed: Apr. 12, 2005

Related U.S. Application Data
(60) Provisional application No. 60/637,688, filed on Dec. 20, 2004.

(51) Int. Cl. A62C 35/00; A62C 37/36; A62C 37/08

(52) U.S. Cl. 169/37; 169/16; 169/19; 169/20

(57) ABSTRACT

A modular fire extinguishing system has a tank holding fire retardant material, an ejection head coupled to the tank for dispersing the fire retardant material, a valve mechanism for releasing the fire retardant material from the tank, an inlet to the tank for pressurizing the tank, and a mechanism for sensing an incipient fire condition and for initiating operation of the valve mechanism to eject the fire retardant material.

### BACKGROUND OF THE INVENTION

1. Field of the Invention

The present invention relates to an improved modular fire extinguishing, prevention and early intervention system. More particularly, this invention pertains to a modular device for adding sprinkler capability to a single room, component or vehicle. This invention provides an alternative to portable fire extinguishing system applications as are known in the art.

2. Discussion of the State of the Art

Building and fire codes generally require that sprinkler systems be installed in modern buildings, particularly commercial buildings and other buildings used by the general public. There are, however, a large number of residences and other buildings built prior to the enforcement of fire codes, and buildings not subject to the fire codes. Owners and managers who may be inclined to install sprinkler systems for such buildings are often intimidated by the very high cost of retrofitting existing buildings, partly because sprinkler systems commonly require that extensive conduit piping be installed in existing ceilings and walls.

In addition to the above, buildings that are fitted with modern sprinkler systems cannot always protect all of the square footage necessary. For example, there may be closets, bathrooms and room add-ons that are not protected adequately. There may also be special areas at high risk for fire, for example, a kitchen area where it is not desirable to flood an entire room or floor of a building because someone left something cooking on the stove.

Further, there are applications where a sprinkler system may not be feasible, such as certain vehicle applications like recreational vehicles (RV's), large common carrier trucks or semi's, boats and even yachts. Commonly portable fire extinguishers are used in these types of applications. The problem then is that fire extinguishers are manually operated by human beings which leaves room for error. In an emergency situation involving a fire it is common for humans involved to panic, to fail to read and understand fire extinguisher operating instructions, and possibly to be physically injured or otherwise unable to lift, point and operate the fire extinguisher in the most effective manner to extinguish the fire in a timely manner.

What is needed and provided by embodiments of the present invention is a modular, self contained sprinkler system capable of being installed and operated in individual specific locations depending on need. The system may be utilized as a substitute for manual fire extinguishers as is known in the art, or as a level of extra protection along with fire extinguishers. The invention in some embodiments can be used to protect specific items such as works of art, music collections and stove tops. For the first time in the art, an automatic modular system of fire protection is provided and installable in individual rooms, vehicles, cabinets and various furniture items.

### SUMMARY OF THE INVENTION

In an embodiment of the present invention a modular fire extinguishing system is provided comprising a tank holding fire retardant material, an ejection head coupled to the tank for dispersing the fire retardant material, a valve mechanism for releasing the fire retardant material from the tank, an inlet to the tank for pressurizing the tank, and a mechanism for sensing an incipient fire condition and for initiating operation of the valve mechanism to eject the fire retardant material.

In one embodiment the ejection head is a conventional sprinkler head integrating the valve mechanism in the sprinkler head. Also in one embodiment there is a separate sensor for sensing heat, smoke or a combination of both, wherein the valve mechanism is disposed between the tank and the ejection head and is caused to open by the sensor mechanism sensing heat, smoke or a combination of both. In this case the sensor may communicate with the valve mechanism over a distance allowing the sensor to be remotely located from the tank and the ejector head.

In other embodiments of the invention there may be a sealable inlet to the tank for reloading the tank with the fire retardant material after a one-shot use, and in various embodiments the fire retardant material may be one of water, water-based material, dry chemical bicarbonate or ammonium phosphates fire retardant, gaseous fire-retardant material, or foam.

In another aspect of the invention a fire control system is provided, comprising a plurality of unconnected, independent, modular units, each comprising a tank holding fire retardant material, an ejection head coupled to the tank for dispersing the fire retardant material, a valve mechanism for releasing the fire retardant material from the tank, an inlet to the tank for pressurizing the tank, and a mechanism for sensing an incipient fire condition and for initiating operation of the valve mechanism to eject the fire retardant material, wherein the plurality of units is deployed in a matrix throughout a zone in a premise to be protected.

In one embodiment of this system the ejection head for individual ones of the modular units may be a conventional sprinkler head integrating the valve mechanism in the sprinkler head. In another embodiment the mechanism for sensing for one of the modular units may sense heat, smoke or a combination of both, and controls the valve mechanisms for individual ones of a plurality of the modular units. In this case the sensor may communicate with the valve mechanisms over a distance allowing the sensor to be remotely located from any one of the modular units.

In some embodiments individual ones of the modular units have a tank further comprising a sealable inlet to the tank for reloading the tank with the fire retardant material after a one-shot use. Also in various embodiments the fire retardant material may be one of water, water-based material, dry chemical bicarbonate or ammonium phosphates fire retardant, gaseous fire-retardant material, or foam.

In yet another aspect of the invention a combination fire extinguisher, furniture unit is provided comprising a component of the furniture implemented as a hollow tank holding fire retardant material, an ejection head coupled to the tank for dispersing the fire retardant material, a valve mechanism for releasing the fire retardant material from the tank, an inlet to the tank for pressurizing the tank, and a mechanism for sensing an incipient fire condition and for initiating operation of the valve mechanism to eject the fire retardant material. In one such embodiment the furniture component is a stand for an upright lamp hollowed to serve as a tank for the fire retardant material.

### BRIEF DESCRIPTION OF THE DRAWINGS

FIG. 1 is a detailed view of a ceiling installation of a modular fire extinguishing system according to an embodiment of the present invention.

FIG. 2A is an example of a number of uses of the modular fire extinguishing system in embodiments of the invention.

FIG. 2B illustrates yet another embodiment of the modular fire extinguishing system in an embodiment of the invention.

FIG. 3A is an example of a cosmetically aesthetic furniture installation of the modular fire extinguishing system in an embodiment of the invention.

FIG. 3B illustrates an embodiment of the invention implemented as an upright lamp.

FIG. 3C illustrates an embodiment of the invention implemented as a corner cabinet.

FIG. 4 shows an example of the modular fire extinguishing system of the invention in an embodiment for use in a recreational vehicle.

### DETAILED DESCRIPTION

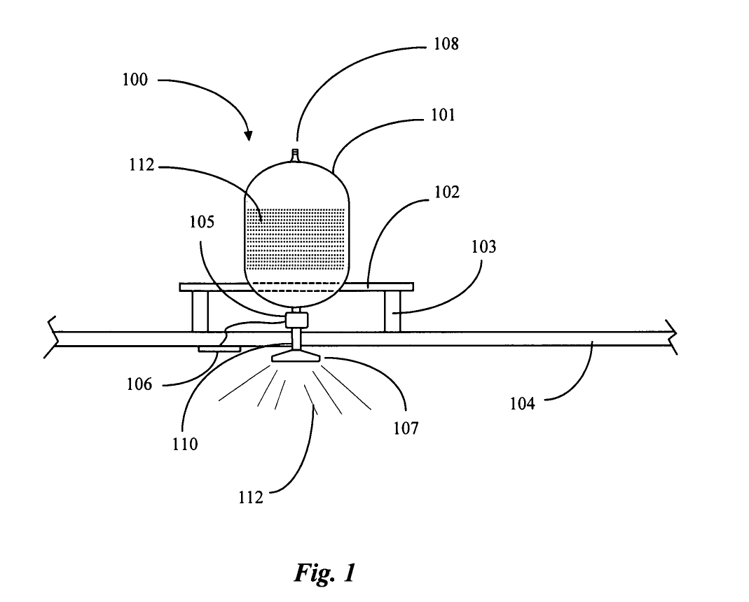

FIG. 1 is an elevation view of a self-contained modular fire extinguishing system 100 in n embodiment of the present invention for adding to a single room or a fire-susceptible space in a residence or other building. The system may provide fire protection for the entire room or for one or more specific objects in the room. In this embodiment the modular system is fashioned to be installed above the ceiling of the room being protected. The attic space above the room, for example, may be utilized for installation. There also may be a crawl space or insulation space providing adequate space for the installation.

The system in this embodiment comprises a relatively small tank 101 to hold a supply of water or other fire extinguishing material 112. Fire extinguishing material 112 may be water based, dry chemical such as bicarbonates or ammonium phosphates, gaseous as in carbon dioxide products or foam. The system is not limited by the types of substances used for extinguishing fires. Tank 101 may be manufactured with a flexible bladder, or may be a solid tank manufactured from light weight materials such as fiberglass or aluminum. Tank 101 may also incorporate one of various shapes as required to fit into tight spaces and is not limited by the shape shown in FIG. 1. The volume of the tank may be commonly approximately five gallons, although the capacity of the tank may vary as required in different applications.

The water or other fire extinguishing material in tank 101 communicates through a valve mechanism 105 to ejection head 107 in this particular embodiment. The valve mechanism 105 may be adjusted or substituted as needed to accommodate different types of fire extinguishing material 112 to be used in tank 101. Ejection head 107 is adapted to permeate the room with the material held in tank 101. Ejection head 107 may emit the material in a shower-like fashion as shown or may disperse the material in a fog or foam depending on the type of valve 105 and ejection head 107 installed in the system.

An input sensor 106 is shown mounted adjacent to ejection head 107 in this embodiment. Sensor 106 may be strategically located in other areas in order to trigger the functions of modular system 100 in the event of a fire, or threat of fire. Input sensor 106 may be located in any convenient position to best sense locations where a fire is most likely to start, such as near a Christmas tree or a stove. Sensor 106 may be manufactured to specifically sense conditions of heat, smoke or a combination of these. Valve mechanism 105 receives direct input from sensor 106 for activating the system. Communication between system 100 and sensor 106 may be via a hardwired connection or by wireless technology. Sensor 106 may be powered by an internal or external battery or connected to hard wired electrical power (not shown).

Ejection of fire retardant material from tank 101 may be by pressure imposed above the material in the tank. The tank may be pressurized by air, or any one o0f several other gases, such as Nitrogen, via a one-way valve 108 shown installed at the top of tank 101. One-way valve 108 may be similar to a common tire inflation valve or of other manufacture which serves the purpose of providing pressure in tank 101.

FIG. 1 illustrates just one type of installation for this embodiment, which is accomplished by fabricating a hole in the ceiling accommodating a conduit 110 extending from tank 101 through the ceiling and connecting to ejection head 107. Structure 102 in this example is securely fastened between rafters 103 of an attic space located above ceiling 104. Structure 102 serves as a reinforcement supporting the system 100 and specifically tank 101 as shown. Conduit 110 may be shorted or extended to accommodate the thickness of ceiling 104 to accommodate the connection between valve 105 and sprinkler head 107.

Ejection head 107 is assembled to conduit 110 from the room side of the ceiling after the tank assembly is installed in the attic. In operation, a fire condition is sensed by sensor 106, by heat, smoke, or a combination. Sensor 106 then sends a signal to valve 105 causing it to open and release fire extinguishing material 112 into conduit 110 and to sprinkler head 107. Tank 101 is pressurized, as described above, and the contents are promptly forced through conduit 110 to sprinkler head 107 dispersing a fine spray, fog of small droplets or foam which promptly squelches the beginning fire.

In another embodiment the actions and sequence above-described are carried out, and the sensor also triggers an alarm, which may be an audible alarm in the home or business, a signal, such as a telephone signal to the local fire department, and so on. In one embodiment the sensor may also sense carbon dioxide levels, and may have capability to trigger an alarm for high levels of carbon monoxide.

In some embodiments the sprinkler head in FIG. 1 is a conventional sprinkler head designed to open and disperse the fire extinguishing material 112 in response to heat from a fire. In this case sensor 106 and remotely-operable valve 105 are not necessary to the operation of the system. This embodiment is especially advantageous as the system may be installed in remote outer buildings, storage containers or vehicles which do not readily have piped-in water or electrical power available to operate the system.

In the embodiment demonstrated in FIG. 1 the operation of modular system 100 is as a one time use or a one-shot operation. In some embodiments the tank may be refillable and reusable. Also in some embodiments the sensor may also trigger an audible alarm, as is done with smoke detectors, for example, and may also trigger an alert, such as a telephone call or other message to a security company or fire department.

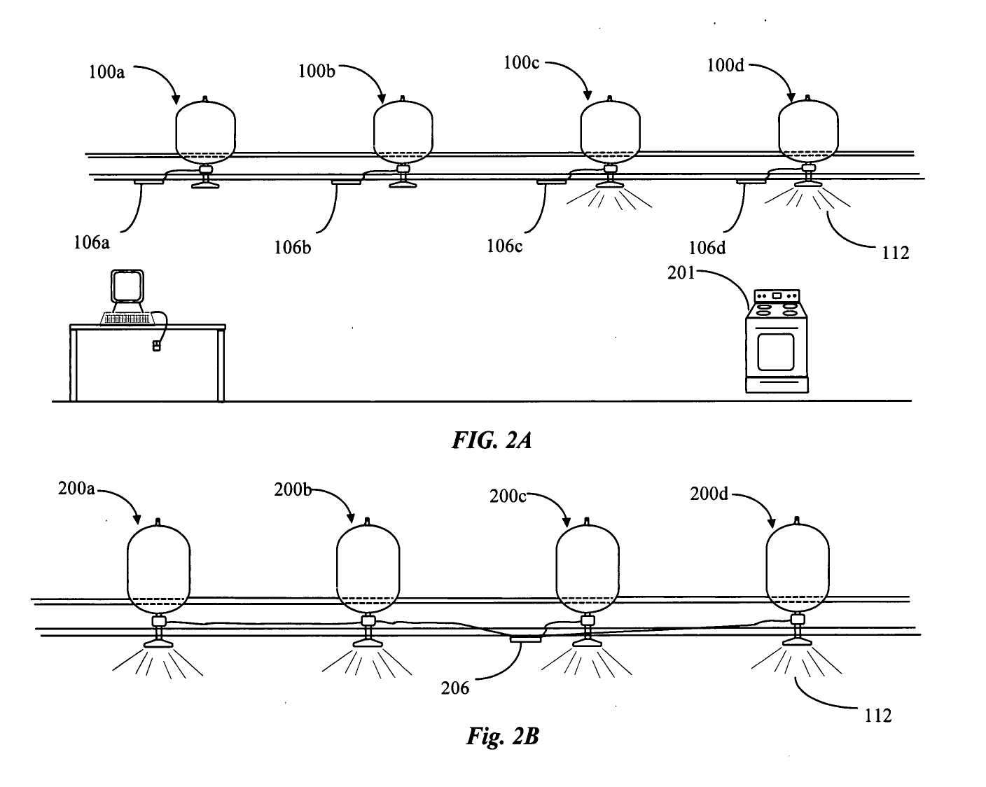

FIG. 2A illustrates an embodiment wherein a plurality of systems as shown in FIG. 1 are utilized to accommodate a space having considerable square footage, wherein one system 100 of FIG. 1 is unable to adequately service the space needing fire protection. In this embodiment systems 100a-100d operate individually in a stand-alone fashion, wherein system 100a is connected to sensor 106a, system 100b is connected to sensor 106b, and so on. In this manner each fire extinguishing system covers protection space of the room individually from other units. For Example if sensor 106d detected a fire condition above the kitchen stove 201, only system 100d would operate to extinguish the fire. The other units would not release their fire extinguishing material 112 until and unless the fire condition reached their perspective areas and triggered the other sensors 106a-c, therefore possibly saving damage and cleanup for such as computer workstation 203.

FIG. 2B illustrates an alternative embodiment wherein all systems 200a-200d operate as a single fire extinguishing unit connected to one sensor 206 enabling operation of the systems in unison. In this example, as shown, all systems 200a-d are connected to one sensor 206. When a fire situation is apparent, sensor 206 triggers all systems 200a-d to disperse their fire extinguishing material 112 simultaneously to extinguish the fire.

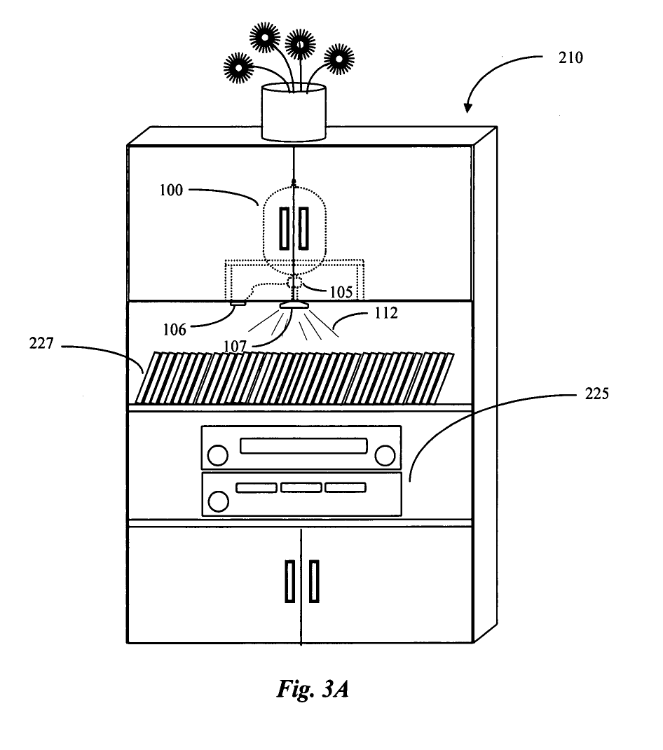

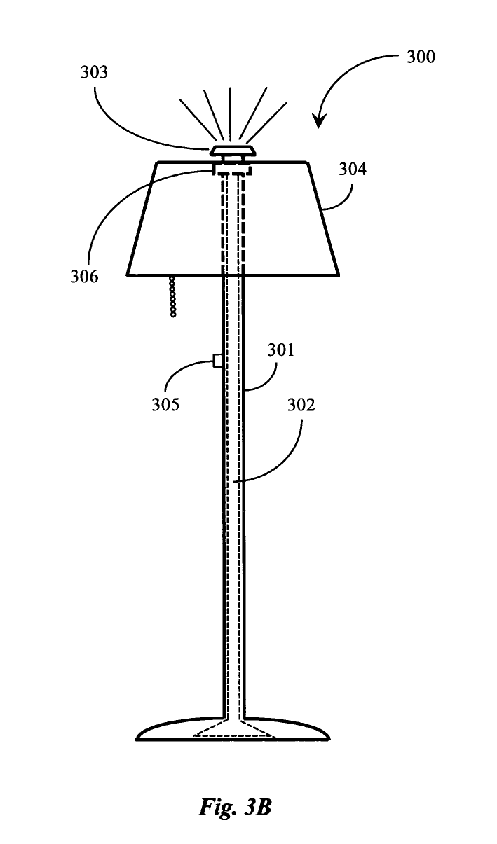

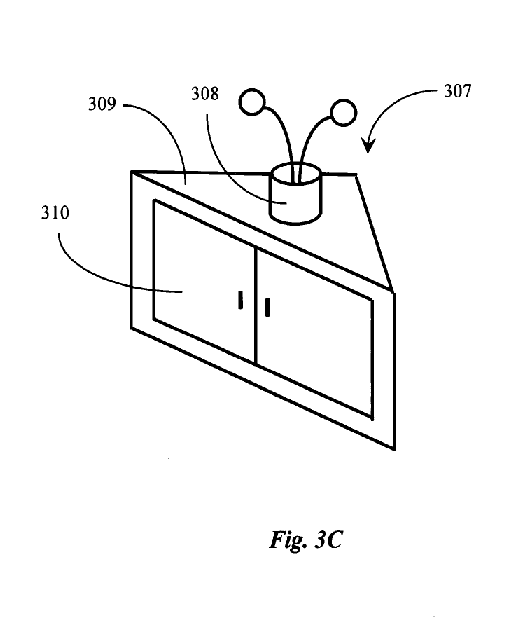

FIG. 3A illustrates another embodiment of the modular fire extinguishing system in an embodiment of the invention, wherein the system is installed in a piece of furniture, for example a cabinet 210, as shown. Here system 100 is used in a very specific fashion to protect a specific object. Cabinet 210 in this example houses a variety of electronic stereo components and an extensive compact disk (CD) music, movie and software collection. An upper portion of cabinet 210 houses modular system 100 as shown. Sensor 106 is positioned in a strategic position above the stereo components. When sensor 106 determines a fire or incipient fire condition exists, valve mechanism 105 opens, releasing pressurized fire extinguishing material 112 to ejection head 107 which extinguishes the fire condition, perhaps preserving the CD collection 227 from being damaged.

In the case of mounting in a specific cabinet or other enclosed location as shown in FIG. 3A, the tank is small, such as no more than one gallon of material, or in many cases much less, like less than one pint or even a single cup of material, which will be sufficient for snuffing out a fire, or a condition in a very small location, that unchecked could result in a disastrous fire. Such units are valuable for mounting in washers, driers, storage units, electrical cabinets, and any of a large variety of such places that are known to be places where fires often initiate.

FIG. 3B illustrates a modular unit according to an embodiment of the present invention, wherein the tank itself is a structural part of a functional piece of furniture, such as an upright lamp 300, or appliance. In the example illustrated stand 301 of the lamp is a hollow unit having an internal volume 302 of about one gallon. An ejector head 303, made to appear as part of the lamp, is positioned in this case above lampshade 304, and the valving mechanism may be integrated in the ejector head, as in conventional sprinkler heads, or placed between the tank and the ejector head, in which case there may be a sensor 305 positioned at a convenient place on or near the lamp stand, and a separate valve 306 between the ejector head and the tank volume. Given the teaching just above relative to a lamp, it will be apparent to the skilled artisan that many other common furniture units may be implemented as fire retardant units, such as table lamps, appliance frames, radios, televisions, side tables, coffee tables, and many other sorts of units of furniture. Basically, any unit in a home or business that has a frame or other component that nay be provided hollow to serve as a tank, can be made into a regional fire-safety unit according to an embodiment of the present invention.

In another embodiment FIG. 3C illustrates a fire-retarding system 307 according to the invention implemented as a corner cabinet. In this embodiment a pressurized tank of fire-retarding material is concealed behind doors 310 in cabinet 309, and an ejection head 308 in communication with the tank through a valving mechanism may be disguised as a common item, like a book or a flower vase, for example. In this embodiment a greater quantity of fire-retardant material may be available than in either of the lamp, of the site-specific situation taught herein with reference to FIGS. 3A and 3B. For example, five gallons of fire-retardant material may be enough to protect an entire room, and to be effective even some time after a fire has started and grown. Such systems may also be rechargeable and reusable.

A major advantage of systems according to embodiments of the invention wherein the systems are implemented as apparent pieces of furniture is that these systems are not a part of the structure of a house or a business building, and can be purchased and installed by renters/lessees who may, when moving to a new apartment or business location, take their fire protection with them.

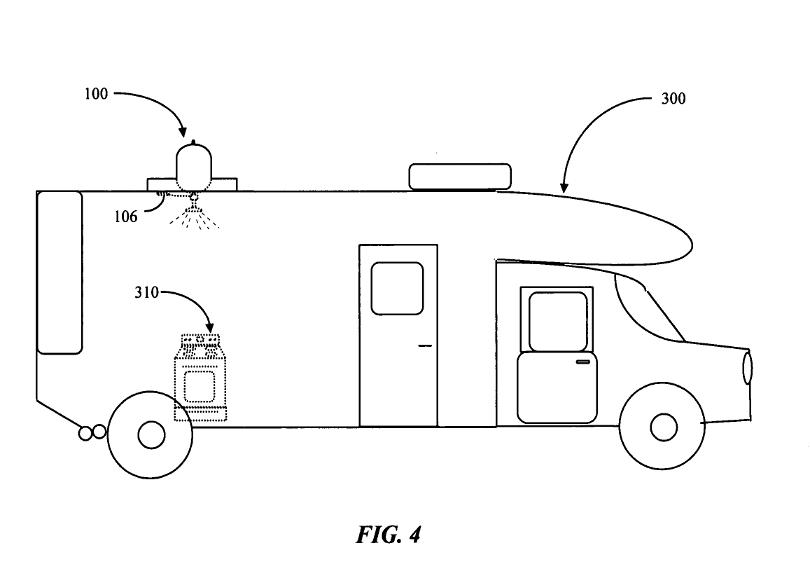

FIG. 4 illustrates an embodiment wherein a system 100 is installed in a recreational vehicle (RV) 300. This is an especially advantageous use of system 100, because RVs are commonly known to hold quantities of propane or other flammable substances. RVs are also constantly in motion and commonly remote from consistent water and power sources. Also, RV's are sometimes stored or parked for long periods of time in unattended garages or storage lots. In this example modular fire extinguishing system 100 is installed from the outside of the RV through the ceiling above propane stove 310. Sensor 106 is also installed above propane stove 310 and the system operates in a similar manner to that explained above with reference to FIG. 1. In other embodiments systems according to the invention may be implemented as furniture for use in the RV according to disclosure above.

The Modular fire extinguishing system as described above, for the first time in the art provides a modular stand-alone means of fire protection without dependency on human operation, piped-in water sources or consistent electrical power. The system also has applications in vehicles such as trains, shipping containers and boats. The examples shown in the invention as described are not meant to be limiting as the invention is applicable for any area or item requiring fire protection affording the space for installation. The invention as described herein is only limited by the claims that follow.

What is claimed is:

1. A modular fire extinguishing system comprising;
a tank holding fire retardant material;
an ejection head coupled to the tank for dispersing the fire retardant material;
a valve mechanism for releasing the fire retardant material from the tank;
an inlet to the tank for pressurizing the tank; and
a mechanism for sensing an incipient fire condition and for initiating operation of the valve mechanism to eject the fire retardant material.

2. The system of claim 1 wherein the ejection head is a conventional sprinkler head integrating the valve mechanism in the sprinkler head.

3. The system of claim 1 further comprising a separate sensor for sensing heat, smoke or a combination of both, wherein the valve mechanism is disposed between the tank and the ejection head and is caused to open by the sensor mechanism sensing heat, smoke or a combination of both.

4. The system of claim 3 wherein the sensor communicates with the valve mechanism over a distance allowing the sensor to be remotely located from the tank and the ejector head.

5. The system of claim 1 further comprising a sealable inlet to the tank for reloading the tank with the fire retardant material after a one-shot use.

6. The system of claim 1 wherein the fire retardant material is one of water, water-based material, dry chemical bicarbonate or ammonium phosphates fire retardant, gaseous fire-retardant material, or foam.

7. A fire control system comprising;
a plurality of unconnected, independent, modular units, each comprising a tank holding fire retardant material, an ejection head coupled to the tank for dispersing the fire retardant material, a valve mechanism for releasing the fire retardant material from the tank, an inlet to the tank for pressurizing the tank, and a mechanism for sensing an incipient fire condition and for initiating operation of the valve mechanism to eject the fire retardant material;
wherein the plurality of units is deployed in a matrix throughout a zone in a premise to be protected.

8. The system of claim 7 wherein the ejection head for individual ones of the modular units is a conventional sprinkler head integrating the valve mechanism in the sprinkler head.

9. The system of claim 7 wherein the mechanism for sensing for one of the modular units, senses heat, smoke or a combination of both, and controls the valve mechanisms for individual ones of a plurality of the modular units.

10. The system of claim 9 wherein the sensor communicates with the valve mechanisms over a distance allowing the sensor to be remotely located from any one of the modular units.

11. The system of claim 7 wherein individual ones of the modular units have a tank further comprising a sealable inlet to the tank for reloading the tank with the fire retardant material after a one-shot use.

12. The system of claim 7 wherein the fire retardant material is one of water, water-based material, dry chemical bicarbonate or ammonium phosphates fire retardant, gaseous fire-retardant material, or foam.

13. A combination fire extinguisher, furniture unit, comprising:
a component of the furniture implemented as a hollow tank holding fire retardant material;
an ejection head coupled to the tank for dispersing the fire retardant material;
a valve mechanism for releasing the fire retardant material from the tank;
an inlet to the tank for pressurizing the tank; and
a mechanism for sensing an incipient fire condition and for initiating operation of the valve mechanism to eject the fire retardant material.

14. The combination unit of claim 13 wherein the furniture component is a stand for an upright lamp hollowed to serve as a tank for the fire retardant material.
